(19) United States
(12) Patent Application Publication
(10) Pub. No.: US 2015/0002553 A1
(43) Pub. Date: Jan. 1, 2015

(54) PIXEL ARRAY

(71) Applicant: AU Optronics Corporation, HSIN-CHU (TW)

(72) Inventors: Meng-Sheng CHANG, HSIN-CHU (TW); Yu-Ting HUANG, HSIN-CHU (TW)

(73) Assignee: AU Optronics Corporation, HSIN-CHU (TW)

(21) Appl. No.: 14/144,317

(22) Filed: Dec. 30, 2013

(30) Foreign Application Priority Data
Jun. 28, 2013 (TW) 102123318

(51) Int. Cl. G09G 3/36

(52) U.S. Cl. CPC G09G 3/3611
USPC 345/690; 345/88

(57) ABSTRACT

A pixel array for use in a display device includes a plurality of data lines and a plurality of scan lines. The pixel array includes a plurality of sub-pixels electrically coupled to the data lines and the scan lines. Two of the sub-pixels with the same color are respectively electrically coupled to two adjacent scan lines, and two of the sub-pixels with the same color are electrically coupled to either side of the same data line.

### RELATED APPLICATIONS

This application claims priority to Taiwan Application Serial Number 102123318, filed Jun. 28, 2013, which is herein incorporated by reference.

### BACKGROUND

1. Field of Invention

The present disclosure relates to a display device, and more specifically relates to a pixel array of a display device.

2. Description of Related Art

Liquid crystal displays (LCDs) are used as display devices because they are able to render high-quality images with minimal driving power. In LCDs, the rod-like and planar-like, flat liquid crystal (LC) molecules are aligned in a specific orientation. The alignment of LC molecules in LC cells of the LC panel is important in determining light transmittance.

The light-transmitting characteristics of LC molecules are changed by the application of a high voltage to an LC layer. If such changes were to become permanent, they would result in irreversible degradation of the display quality of the LC display panel. To avoid such degradation, the voltage signals provided to the LC cells should be changed constantly. In most cases, a source driver is disposed according to polarity inversion (for example, frame inversion, row inversion, column inversion, dot inversion and 2-line inversion) to generate voltage signals with alternating polarities.

An LCD display with a zigzag disposition can use a column inversion driving method. With such a structure and operation, the power consumption of the LCD display is low when the LCD display displays white or black images. However, the pulse transition phenomenon is encountered at a voltage provided by a data line which is used to provide image data when the LCD display displays a monochromatic image or a complementary color image, and this leads to increased power consumption of the LCD display.

Many in the related field have endeavored to find a solution to the aforementioned problems. Nonetheless, there is still a need to improve existing apparatuses and techniques in the art.

### SUMMARY

The following presents a simplified summary of the disclosure in order to provide a basic understanding to the reader. This summary is not an extensive overview of the disclosure and it does not identify key/critical elements of the present invention or delineate the scope of the present invention.

The present invention provides a pixel array which improves the problem of increased power consumption of a display device caused by pulse transition.

One aspect of the embodiment of the present invention is to provide a pixel array for use in a display device. The pixel array includes a plurality of data lines and a plurality of scan lines. The pixel array includes a plurality of sub-pixels which are electrically coupled to the data lines and the scan lines. Two of the sub-pixels with the same color are respectively electrically coupled to two adjacent scan lines, and two of the sub-pixels with the same color are electrically coupled to either side of the same data line.

Another aspect of the embodiment of the present invention is to provide a pixel array for use in a display device. The display device includes plurality of data lines and a plurality of scan lines. The pixel array includes a plurality of sub-pixels which are electrically coupled to the data lines and the scan lines. Any two of the sub-pixels with the same color in adjacent columns are respectively electrically coupled to either side of the same data line.

Many of the attendant features and advantages of the present disclosure will become better understood with reference to the following detailed description.

### BRIEF DESCRIPTION OF THE DRAWINGS

The invention can be more fully understood by reading the following detailed description of the embodiments, with reference made to the accompanying drawings as follows:

FIG. 1 schematically shows a pixel array according to embodiments of the present invention.

In accordance with common practice, the various described features/elements are not drawn to scale but instead are drawn to best illustrate specific features/elements relevant to the present invention. Also, like reference numerals and designations in the various drawings are used to indicate like elements/parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise. Also, as used herein and in the claims, the terms “at least one” and “one or more” have the same meaning and include one, two, three, or more.

Moreover, as used herein, the terms “couple” or “connect” refer to the physical or electrical contacts between two or more elements with each other, either directly or indirectly, or the mutual operation or interaction between two or more elements.

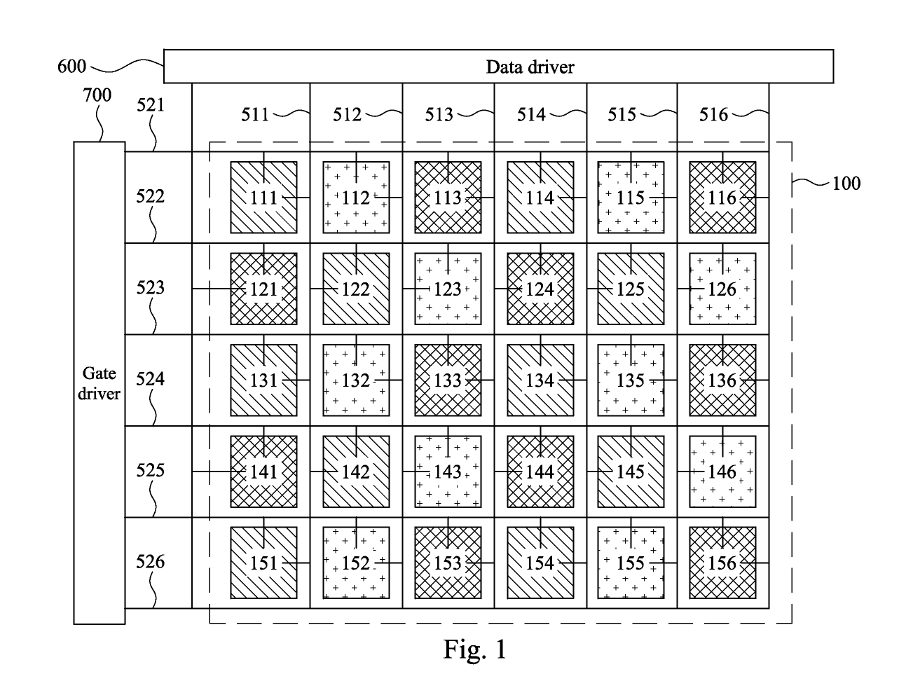

To address the problems existing in the prior art, the present disclosure provides a display device, and a pixel array 100 of the display device is arranged in a specific pattern that solves the problem of increased power consumption of the display device caused by pulse transition. The display device is shown in FIG. 1.

As shown in FIG. 1, the display device includes a plurality of data lines 511-516, a plurality of scan lines 521-526, a data driver 600, a gate driver 700 and the pixel array 100. The pixel array 100 includes a plurality of sub-pixels 111-156, and the sub-pixels 111-156 are electrically coupled to the data lines 511-516 and the scan lines 521-526. In greater detail, in the pixel array 100, two of the sub-pixels with the same color (such as the sub-pixels 111, 122) are respectively electrically coupled to two adjacent scan lines (such as the scan lines 521, 522), and two of the sub-pixels with the same color (such as the sub-pixels 111, 122) are electrically coupled to either side of the same data line (such as 511).

Through the arrangement of the pixel array 100 of the display device of the embodiment of the present invention, when the display device is being used to display a monochromatic image or a complementary color image on the screen, since two sub-pixels with the same color are electrically coupled to the same data line, each data line of the display device will only be electrically coupled to sub-pixels with the same color. As a result, pulse transition may effectively be eliminated in the pixel array 100 of the display device of the embodiment of the present invention, and consequently, the pixel array 100 of the display device of the embodiment of the present invention improves the problem of increased power consumption of the display device caused by pulse transition.

Specifically, the pixel array 100 of embodiments of the present invention may be arranged in a zigzag configuration as shown in FIG. 1. The data line 511 is electrically coupled to the first, the third, and the fifth sub-pixels in the same column as the sub-pixel 111, and electrically coupled to the second and the fourth sub-pixels in the same column as the sub-pixel 112. That is, the data line 511 is coupled to every other sub-pixel in the same column. As a result, the data line 511 and the sub-pixels connected thereto, as a whole, are arranged in a zigzag configuration.

With the pixel array 100 configuration described above, if the same color sub-pixels were to be arranged in the same column, for instance, all red sub-pixels disposed in the same column as the sub-pixel 111 and all green sub-pixels disposed in the same column as the sub-pixel 112, when the display device is to display red, the data driver 600 would provide a data signal to the data line 511. At this time, since the second and the fourth sub-pixels in the same column as the sub-pixel 112 which are coupled to the data line 511 are green sub-pixels, and the green sub-pixels would be turned-off since they cannot display red, the voltage of the data line 511 would cause pulse transition.

To solve the problem of pulse transition, the pixel array 100 is arranged in a specific pattern. In particular, a number of the sub-pixels in the same column as the sub-pixel 111 and including the sub-pixel 111, namely, the sub-pixel 111, the sub-pixel 131 and the sub-pixel 151, are electrically coupled to the data line 511 and have the same color. Also, a number of the sub-pixels in the same column as the sub-pixel 112, namely, the sub-pixel 122 and the sub-pixel 142 are electrically coupled to the data line 511 and have the same color, which is the same as the color of the sub-pixels 111, 131, 151. Thus, the same data line of the display device is only electrically coupled to sub-pixels with the same color, and such a configuration solves the problem of increased power consumption of the display device caused by pulse transition.

As shown in FIG. 1, for example, the sub-pixels 111, 122, 131, 142, 151 which are electrically coupled to the data line 511 are all red sub-pixels, the sub-pixels 112, 123, 132, 143, 152 which are electrically coupled to the data line 512 are all green sub-pixels, and the sub-pixels 113, 124, 133, 144, 153 which are electrically coupled to the data line 513 are all blue sub-pixels. The rest of the sub-pixels in the pixel array 100 may be arranged in the same way. However, the present invention is not limited in this regard, and those of ordinary skill in the art may, within the spirit of the present embodiments, selectively adopt an appropriate arrangement to implement the present invention according to actual requirements.

Subsequently, different technical features of the pixel array 100 of the present invention are described below. In one embodiment, the data lines 511-516 may include the first data line 511, and the scan lines 521-526 may include the first scan line 521 and the second scan line 522. The sub-pixels include at least two red sub-pixels (such as the sub-pixels 111, 122), and the at least two red the sub-pixels (such as the sub-pixels 111, 122) are respectively electrically coupled to the first scan line 521 and the second scan line 522. Moreover, the at least two red sub-pixels (such as the sub-pixels 111, 122) are respectively electrically coupled to either side of the first data line 511.

In another embodiment, the data lines 511-516 may further include a second data line 512, and the sub-pixels may further include at least two green sub-pixels (such as the sub-pixels 112, 123). The at least two green sub-pixels (such as the sub-pixels 112, 123) are respectively electrically coupled to the first scan line 521 and the second scan line 522, and the at least two green sub-pixels (such as the sub-pixels 112, 123) are respectively electrically coupled to either side of the second data line 512.

In yet another embodiment, the data lines 511-516 may further include a third scan line 513, and the sub-pixels may further include at least two blue sub-pixels (such as the sub-pixels 113, 124). The at least two blue sub-pixels (such as the sub-pixels 113, 124) are respectively electrically coupled to the first scan line 521 and the second scan line 522, and the at least two blue sub-pixels (such as the sub-pixels 113, 124) are respectively electrically coupled to either side of the third scan line 513.

In still another embodiment, the data lines 511-516 and the scan lines 521-526 may jointly define a first row, a second row, a first column and a second column of the pixel array 100. The sub-pixels may include at least two red sub-pixels (such as the sub-pixels 111, 122). One of the at least two red sub-pixels (such as the sub-pixel 111) is disposed in the first row and the first column of the pixel array 100, and the other of the at least two red sub-pixels (such as the sub-pixel 122) is disposed in the second row and the second column of the pixel array 100.

In yet another embodiment, the data lines 511-516 and the scan lines 521-526 may further jointly define a third column of the pixel array 100. The sub-pixels may include at least two green sub-pixels (such as the sub-pixels 112, 123). One of the at least two green the sub-pixels (such as the sub-pixel 112) is disposed in the first row and the second column of the pixel array 100, and the other of the at least two green sub-pixels (such as the sub-pixel 123) is disposed on the second row and the third column of the pixel array 100.

In still another embodiment, the data lines 511-516 and the scan lines 521-526 may further jointly define a fourth column of the pixel array 100. The sub-pixels may include at least two blue sub-pixels (such as the sub-pixels 113, 124). One of the at least two blue sub-pixels (such as the sub-pixel 113) is disposed in the first row and the third column of the pixel array 100, and the other of the at least two blue sub-pixels (such as the sub-pixel 124) is disposed in the second row and the fourth column of the pixel array.

In yet another embodiment, the scan lines 521-526 may define a first row and a second row of the pixel array 100. The sub-pixels may include at least six sub-pixels 111, 112, 113, 121, 122, 123. The sequence of the sub-pixels disposed in the first row of the pixel array 100 are the first red sub-pixel 111, the first green sub-pixel 112 and the first blue sub-pixel 113, and the sequence of the sub-pixels disposed in the second row of the pixel array 100 are the second blue sub-pixel 121, the second red sub-pixel 122, and the second green sub-pixel 123.

In still another embodiment, the data lines 511-516 may define a first column of the pixel array 100. The sub-pixels with the same color (such as the sub-pixels 111, 131) are disposed as every other sub-pixel in the first column.

In yet another embodiment, the scan lines 521-526 may define a first row, a second row, and a third row of the pixel array 100. One of two sub-pixels with the same color (such as the sub-pixel 111) is disposed in the first row and the first column of the pixel array 100, and the other of the two sub-pixels with the same color (such as the sub-pixel 131) is disposed in the third row and the first column of the pixel array 100.

In some embodiments, the data lines include a first data line 511 and a second data line 512, and the sub-pixels include a first red sub-pixel 111, a second red sub-pixel 122, a first green sub-pixel 112, and a second green sub-pixel 123, wherein the first red sub-pixel 111 and the second red sub-pixel 122 are electrically coupled to the first data line 511, and the first green sub-pixel 112 and the second green sub-pixel 123 are electrically coupled to the second data line 512.

In various embodiments, the data lines include a third data line 513, and the sub-pixels include a first blue sub-pixel 113 and a second blue sub-pixel 124, wherein the first blue sub-pixel 113 and the second blue sub-pixel 124 are electrically coupled to the third data line 513.

In some embodiments, the scan lines include a first scan line 521 and a second scan line 522, and the first red sub-pixel 111, the first green sub-pixel 112, and the first blue sub-pixel 113 are electrically coupled to the first scan line 521.

In various embodiments, the second red sub-pixel 122, the second green sub-pixel 123, and the second blue sub-pixel 124 are electrically coupled to the second scan line 522.

In some embodiments, the data lines define a first column of the pixel array, and the sub-pixels include a red sub-pixel 111 and a blue sub-pixel 121. The red sub-pixel 111 and the blue sub-pixel 121 are disposed in the first column in an alternating manner.

In various embodiments, the data lines define a second column of the pixel array, and the sub-pixels include a green sub-pixel 112 and a red sub-pixel 122, and the green sub-pixel 112 and the red sub-pixel 122 are disposed in the second column in an alternating manner.

In some embodiments, the data lines define a third column of the pixel array, and the sub-pixels include a blue sub-pixel 113 and a green sub-pixel 123. The blue sub-pixel 113 and the green sub-pixel 123 are disposed in the third column in an alternating manner.

In another embodiment, as shown in FIG. 1, the pixel array 100 is applied in the display device. The display device may include a plurality of data lines 511-516 and a plurality of scan lines 521-526. The pixel array 100 may include a plurality of the sub-pixels 111-156, and the sub-pixels 111-156 are electrically coupled to the data lines 511-516 and the scan lines 521-526, in which any two of the sub-pixels with the same color in adjacent columns are respectively electrically coupled to either side of the same data line.

For example, the red sub-pixels 111, 122 which are disposed in adjacent columns may be respectively electrically coupled to either side of the same data line 511. The green the sub-pixels 122, 123 which are disposed in adjacent columns are respectively electrically coupled to either side of the same data line 512. The blue sub-pixels 113, 124 which are disposed in adjacent columns are respectively electrically coupled to either side of the same data line 513, and the rest of the sub-pixels are arranged in the same way.

Similarly, in this aspect, through the arrangement of the pixel array 100 of the display device of the embodiment of the present invention, when the display device is being used to display a monochromatic image or a complementary color image on the screen, since two sub-pixels which are disposed in adjacent columns with the same color are electrically coupled to the same data line, each data line of the display device will only be electrically coupled to sub-pixels with the same color. As a result, pulse transition may effectively be eliminated in the pixel array 100 of the display device of the embodiment of the present invention, and consequently, the pixel array 100 of the display device of the embodiment of the present invention improves the problem of increased power consumption of the display device caused by pulse transition.

In one embodiment, any two of the sub-pixels with the same color in adjacent columns are respectively electrically coupled to different scan lines. For example, the red sub-pixels 111, 122 in adjacent columns are respectively electrically coupled to the scan lines 521, 522. The green sub-pixels 112, 123 in adjacent columns are respectively electrically coupled to the scan lines 521, 522. The blue sub-pixels 113, 124 in adjacent columns are respectively electrically coupled to the scan lines 521, 522, and the rest of the sub-pixels are disposed in the same way.

In another embodiment, any two of the sub-pixels with the same color in adjacent columns are disposed on different rows. For example, the red the sub-pixels 111, 122 in adjacent columns are respectively disposed on the first row and the second row. The green sub-pixels 112, 123 in adjacent columns are respectively disposed on the first row and the second row. The blue sub-pixels 113, 124 in adjacent columns are respectively disposed on the first row and the second row, and the rest of the sub-pixels are disposed in the same way.

In view of the foregoing embodiments of the present invention, many advantages of the present invention are now apparent. The embodiments of the present invention provide the pixel array such that pulse transition may effectively be eliminated, thereby solving the problem of increased power consumption of the display device caused by pulse transition.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A pixel array for use in a display device, the display device comprising a plurality of data lines and a plurality of scan lines, the pixel array comprising:
a plurality of sub-pixels electrically coupled to the data lines and the scan lines, wherein two of the sub-pixels with the same color are respectively electrically coupled to two adjacent scan lines, and two of the sub-pixels with the same color are electrically coupled to either side of the same data line.

2. The pixel array according to claim 1, wherein the data lines comprise a first data line, the scan lines comprise a first scan line and a second scan line, and the sub-pixels comprise at least two red sub-pixels, wherein the at least two red sub-pixels are respectively electrically coupled to the first scan line and the second scan line, and the at least two red sub-pixels are respectively electrically coupled to either side of the first data line.

3. The pixel array according to claim 2, wherein the data lines further comprise a second data line, and the sub-pixels further comprise at least two green sub-pixels, wherein the at least two green sub-pixels are respectively electrically coupled to the first scan line and the second scan line, and the at least two green sub-pixels are respectively electrically coupled to either side of the second data line.

4. The pixel array according to claim 3, wherein the data lines further comprise a third data line, and the sub-pixels further comprise at least two blue sub-pixels, wherein the at least two blue sub-pixels are respectively electrically connected to the first scan line and the second scan line, and the at least two blue sub-pixels are respectively electrically coupled to either side of the third data line.

5. The pixel array according to claim 1, wherein the data lines and the scan lines jointly define a first row, a second row, a first column and a second column of the pixel array, wherein the sub-pixels comprise at least two red sub-pixels, and one of the at least two red sub-pixels is disposed on the first row and the first column of the pixel array, and the other of the at least two red sub-pixels is disposed on the second row and the second column of the pixel array.

6. The pixel array according to claim 5, wherein the data lines and the scan lines jointly define a third column of the pixel array, wherein the sub-pixels comprise at least two green sub-pixels, and one of the at least two green sub-pixels is disposed on the first row and the second column of the pixel array, and the other one of the at least two green sub-pixels is disposed on the second row and the third column of the pixel array.

7. The pixel array according to claim 6, wherein the data lines and the scan lines jointly define a fourth column of the pixel array, wherein the sub-pixels comprise at least two blue sub-pixels, and one of the at least two blue sub-pixels is disposed on the first row and the third column of the pixel array, and the other one of the at least two blue sub-pixels is disposed on the second row and the fourth column of the pixel array.

8. The pixel array according to claim 1, wherein the scan lines define a first row and a second row of the pixel array, and a plurality of the sub-pixels comprise at least six sub-pixels, wherein the sub-pixels disposed in the first row of the pixel array are a first red sub-pixel, a first green sub-pixel, and a first blue sub-pixel sequentially, wherein the sub-pixels disposed in the second row of the pixel array are a second blue sub-pixel, a second red sub-pixel, and a second green sub-pixel sequentially.

9. The pixel array according to claim 1, wherein the data lines define a first column of the pixel array, wherein the sub-pixels with a first color are disposed in the first column in an alternating manner.

10. The pixel array according to claim 9, wherein the scan lines define a first row, a second row, and a third row of the pixel array, and one of the sub-pixels with a second color is disposed in the first row and the first column of the pixel array, and another one of the sub-pixels with the second color is disposed in the third row and the first column of the pixel array.

11. The pixel array according to claim 1, wherein the data lines comprise a first data line and a second data line, and the sub-pixels comprises a first red sub-pixel, a second red sub-pixel, a first green sub-pixel, and a second green sub-pixel, wherein the first red sub-pixel and the second red sub-pixel are electrically coupled to the first data line, and the first green sub-pixel and the second green sub-pixel are electrically coupled to the second data line.

12. The pixel array according to claim 11, wherein the data lines comprise a third data line, and the sub-pixels comprises a first blue sub-pixel and a second blue sub-pixel, wherein the first blue sub-pixel and the second blue sub-pixel are electrically coupled to the third data line.

13. The pixel array according to claim 12, wherein the scan lines comprise a first scan line and a second scan line, and the first red sub-pixel, the first green sub-pixel, and the first blue sub-pixel are electrically coupled to the first scan line.

14. The pixel array according to claim 13, wherein the second red sub-pixel, the second green sub-pixel, and the second blue sub-pixel are electrically coupled to the second scan line.

15. The pixel array according to claim 1, wherein the data lines define a first column of the pixel array, and the sub-pixels comprise a red sub-pixel and a blue sub-pixel, wherein the red sub-pixel and the blue sub-pixel are disposed in the first column in an alternating manner.

16. The pixel array according to claim 15, wherein the data lines define a second column of the pixel array, and the sub-pixels further comprise a green sub-pixel, wherein the green sub-pixel and the red sub-pixel are disposed in the second column in an alternating manner.

17. The pixel array according to claim 16, wherein the data lines define a third column of the pixel array, wherein the blue sub-pixel and the green sub-pixel are disposed in the third column in an alternating manner.

18. A pixel array for use in a display device, the display device comprising a plurality of data lines and a plurality of scan lines, and the pixel array comprising:
a plurality of sub-pixels electrically coupled to the data lines and the scan lines, wherein any two of the sub-pixels with the same color in adjacent columns are respectively electrically coupled to either side of the same data line.

19. The pixel array of claim 18, wherein any two of the sub-pixels with the same color in adjacent columns are respectively coupled to different data lines.

20. The pixel array of claim 19, wherein any two of the sub-pixels with the same color in adjacent columns are disposed on different rows.
